(19) United States
(12) Patent Application Publication
(10) Pub. No.: US 2024/0397346 A1
(43) Pub. Date: Nov. 28, 2024

(54) SYSTEMS AND METHODS FOR ON-DEMAND NETWORK CONTROLS

(71) Applicant: Verizon Patent and Licensing Inc., Basking Ridge, NJ (US)

(72) Inventors: Raghuram Parvataneni, Frisco, TX (US); Sudhakar Reddy Patil, Flower Mound, TX (US); Ambreen Habib, Golden, CO (US); Syed Rehman, Monmouth Junction, NJ (US)

(21) Appl. No.: 18/324,200

(22) Filed: May 26, 2023

(51) Int. Cl. H04W 24/02; H04W 12/06; H04W 28/24

(52) U.S. Cl. CPC H04W 24/02; H04W 12/06; H04W 28/24

(57) ABSTRACT

Systems and methods provide for on-demand configuration of enhanced quality of service (QOS), of subscriber sessions, by application developers. A network device receives, via an external interface, a service request for a bearer associated with an external application. The network device performs authentication and authorization for the service request, and generates a network configuration request for a core network, based on information in the service request. The network device sends, in response to receiving the service request, the network configuration request to an exposure function in the core network.

### BACKGROUND

New cellular networks (e.g., Fifth Generation (5G) networks) can provide various services and applications, to user devices, with optimized latency and quality of service. Applications may be configured with a subscription to services to provide an optimal user experience for the end user. Application developers/providers may select service levels for their applications that use network services, defining parameters such as a minimum latency requirement and a minimum bandwidth for their application. However, from both network-side and end device-side perspectives, some service configurations may reduce the efficient use of resources.

### BRIEF DESCRIPTION OF THE DRAWINGS

FIG. 1 is a diagram illustrating a network environment according to an implementation described herein;

FIG. 2 is a block diagram illustrating exemplary network components in a portion of the network environment of FIG. 1;

FIG. 3 is a block diagram illustrating functional components and communications of a network controller system, according to an implementation described herein;

FIG. 4 is a diagram illustrating features of an external API, according to an implementation;

FIGS. 5A and 5B are signal flow diagrams illustrating internal communications within the network controller system;

FIG. 6 is a diagram illustrating exemplary components of a device that may be included in a component described herein; and

FIG. 7 is a flow diagram illustrating an exemplary process for providing on-demand configuration of enhanced quality of service (QOS), according to an implementation described herein.

### DETAILED DESCRIPTION

The following detailed description refers to the accompanying drawings. The same reference numbers in different drawings identify the same or similar elements. Also, the following detailed description does not limit the invention.

Systems and methods described herein provide for on-demand configuration of enhanced quality of service (QOS) and other network configurations, of subscriber sessions, by application developers. A network controller system acts as an application function (AF), interfaces with core network elements on standard interfaces, and exposes an application programming interface (API), on an external interface, for application developers for on-demand configuration of a QoS session. The network controller system described herein can support variations of enhanced differentiated QoS, such as low latency, high bandwidth, or a combination of thereof.

Currently, an external application may use a service capability exposure function (SCEF) for Fourth Generation (4G) networks or network exposure function (NEF) for Fifth Generation (5G) networks to configure network parameters via a respective T8 or N33 interface. However, interfacing with an SCEF API or an NEF API is not developer-friendly and requires understanding of 4G and 5G core networks to interpret the APIs and data structure. Additionally, the SCEF/NEF may not be able to expose services to external non-trusted applications. Therefore, there is a need for a service layer (e.g., an AF) that can abstract the complexity of telecommunications, handle authentication and authorization of external applications, and provide a user-friendly API for application developers to easily configure network parameters (e.g., such as QoS) on a telecommunications network. The network controller system described herein provides a simplified API to allow application developers to configure certain network parameters for user sessions.

To avoid overload of core network signaling with multiple dedicated QoS session requests per user equipment (UE) device, network operators may want to permit only a single session per UE device (also referred to simply as a UE). A single dedicated QoS session could support multiple flows (e.g., data flows, also referred to as QoS flows), from different applications, up to a maximum number of flows the UE can support. If a UE supports up to a maximum of 8 flows, for example, a dedicated QoS session could be configured with 8 different flows. There is a need for a service layer that would map the application request to the flow on a single QoS session and take care of terminating the flow when the request duration expires. Additionally, the service layer can implement backoff logic and mark the UE as unavailable, for specified time, to avoid frequent session requests. The network controller system described herein provides these functionalities.

Additionally, a mobile network may support various radio access technology (RAT) frequency selection priority (RFSP) values at a subscriber level for scheduling and prioritizing user sessions, for enhanced QoS, on a radio access network (RAN) interface. The RAN elements (e.g., a gNB, AMF, etc.) may retrieve the RFSP value of a subscriber from a core network (e.g., a home subscriber server (HSS)) during connectivity procedures. The RFSP values are closely associated with QoS class identifier (QCI) values for end-to-end QoS support across the network. However, the provisioning of RFSP is done during the subscriber onboarding in a static manner in 4G/5G networks. In order to support QoS configuration on demand, there is a need for dynamic provisioning of RFSP values. The network controller system described herein supports dynamic provisioning of RFSP value by interfacing with the HSS via an OSS/IT tool.

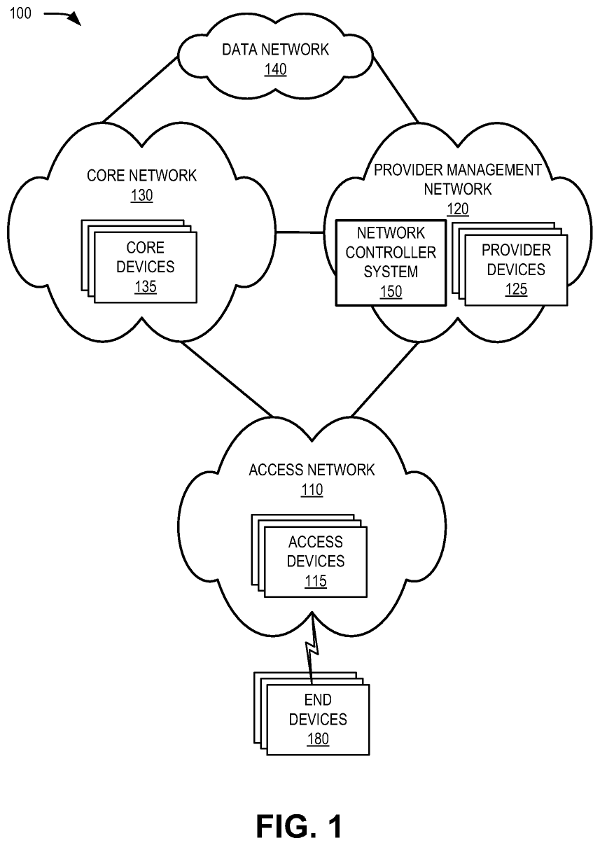

FIG. 1 is a diagram of an exemplary environment 100 in which systems and/or methods, described herein, may be implemented. As illustrated, environment 100 includes access network 110, a provider management network 120, a core network 130, and an external data network 140. Access network 110 includes access devices 115 (also referred to individually or generally as access device 115). Provider management network 120 includes provider devices 125 (also referred to individually or generally as provider device 125). Core network 130 includes core devices 135 (also referred to individually or generally as core device 135). Environment 100 further includes a network controller system 150 and end devices 180 (also referred to individually or generally as end device 180).

The number, type, and arrangement of networks illustrated in environment 100 are exemplary. For example, according to other exemplary embodiments, environment 100 may include fewer networks, additional networks, and/or different networks. For example, according to other exemplary embodiments, other networks not illustrated in FIG. 1 may be included, such as an X-haul network (e.g., backhaul, mid-haul, fronthaul, etc.), a transport network, or another type of network that may support a wireless service and/or an application service, as described herein.

The number, the type, and the arrangement of network devices, and the number of end devices 180, are exemplary. A network device may be implemented according to one or multiple architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge network, fog network, and/or another type of computing architecture, and may be incorporated into various types of network architectures (e.g., software defined network (SDN), virtual network, logical network, network slice, etc.).

Environment 100 includes communication links between the networks, between the network devices, and between end devices 180 and the network/network devices. Environment 100 may be implemented to include wired, optical, and/or wireless communication links. A connection via a communication link may be direct or indirect. For example, an indirect connection may involve an intermediary device and/or an intermediary network not illustrated in FIG. 1. A direct communication connection may not involve an intermediary device and/or an intermediary network. The number, type, and arrangement of communication links illustrated in environment 100 are exemplary. Environment 100 may also include various planes of communication including, for example, a control plane, a user plane, a service plane, and/or a network management plane. Environment 100 may include other types of planes of communication.

Access network 110 may include one or multiple networks of one or multiple types and technologies. For example, access network 110 may be implemented to include a 5G-access network (5G-AN) or a 5G-RAN, a future generation RAN (e.g., a 6G RAN or subsequent generation RAN). Access network 110 may also include a legacy RAN (e.g., a Third Generation (3G) RAN, a 4G or 4.5 RAN, etc.). Access network 110 may communicate with and/or include other types of access networks, such as, for example, a WI-FI network, a local area network (LAN), a Citizens Broadband Radio System (CBRS) network, a cloud RAN, a virtualized RAN (vRAN), a self-organizing network (SON), a wired network (e.g., optical, cable, etc.), or another type of network that provides access to access network 110, provider management network 120, and/or core network 130.

Depending on the implementation, access network 110 may include one or multiple types of network devices, such as access devices 115. For example, access device 115 may include a next generation Node B (gNB), an evolved Node B (eNB), an evolved Long Term Evolution (eLTE) eNB, a remote radio head (RRH), a baseband unit (BBU), a radio unit (RU), a centralized Unit (CU), a CU control plane (CU CP), a CU user plane (CU UP), a distributed unit (DU), a small cell node (e.g., a picocell device, a femtocell device, a microcell device, a home eNB, etc.), open network devices (e.g., O-RAN Centralized Unit (O-CU), O-RAN Distributed Unit (O-DU), O-RAN next generation Node B (O-gNB), O-RAN evolved Node B (O-eNB)), 5G ultra-wide band (UWB) nodes, a future generation wireless access device (e.g., a 6G wireless station, etc.), another type of wireless node (e.g., a WI-FI device, a WiMAX device, a hotspot device, etc.) that provides a wireless access service, or another type of network device that provides a transport service (e.g., routing and forwarding service), such as a router, a switch, or another type of layer 3 (e.g., network layer of the Open Systems Interconnection (OSI) model) network device. Additionally, or alternatively, access device 115 may include a wired and/or optical device (e.g., modem, wired access point, optical access point, Ethernet device, etc.) that provides network access.

Provider management network 120 may include one or multiple networks of one or multiple types and technologies. For example, provider management network 120 may be implemented to include a service or an application-layer network, a cloud network, a private network, a public network, a multi-access edge computing (MEC) network, a fog network, the Internet, a service provider network, software defined network (SDN), a virtual network, a packet-switched network, a data center, or other type of network that may provide access to and may host an end device application, service, or asset (also referred to as an “application service”). In another implementation, all or portions of provider management network 120 may be incorporated within core network 130. According to an exemplary embodiment, provider management network 120 may include network controller system 150, as described herein.

Depending on the implementation, provider management network 120 may include various network devices such as provider devices 125. For example, provider devices 125 may include servers (e.g., web, application, cloud, etc.), mass storage devices, data center devices, network function virtualization (NFV) devices, devices hosting containers, virtual machines, SDN devices, cloud computing devices, platforms, and other types of network devices, and/or platforms implemented or arranged in accordance with architectures pertaining to various network-related functions (e.g., security, management, charging, billing, authentication, authorization, policy enforcement, development, etc.). In one implementation, provider devices 125 may operate network controller system 150.

Core network 130 may include one or multiple networks of one or multiple network types and technologies. For example, core network 130 may be implemented to include a Next Generation Core (NGC or 5GC) network, an Evolved Packet Core (EPC) of an LTE network, an LTE-Advanced (LTE-A) network, and/or an LTE-A Pro network, a future generation core network (e.g., a 6G or beyond core network, etc.), and/or another type of core network. According to an embodiment, core network 130 may include some or all of network controller system 150, as described herein.

Depending on the implementation, core network 130 may include various types of network devices that are illustrated in FIG. 1 as core devices 135. For example, core devices 135 may include 5G network functions, such a user plane function (UPF), a Non-3GPP Interworking Function (N3IWF), an access and mobility management function (AMF), a session management function (SMF), a unified data management function (UDM), a unified data repository function (UDR), an authentication server function (AUSF), a network data analytics function (NWDAF), an application function (AF), etc. In other implementations, core devices 135 may include 4G network functions, such as a mobility management entity (MME), an HSS, a service capability exposure function (SCEF), and a packet gateway (PGW). Core devices 135 may also include a network device that provides a multi-RAT functionality (e.g., 4G and 5G), such as an SMF with PGW control plane functionality (e.g., SMF/PGW-C), a UPF with PGW user plane functionality (e.g., UPF/PGW-U), a SCEF with a NEF (NEF/SCEF), and/or other combined nodes (e.g., an HSS with a UDM and/or UDR, an MME with an AMF, etc.). According to other exemplary implementations, core devices 135 may include additional, different, and/or fewer network devices than those described.

Data network 140 may include, for example, a packet data network. In an exemplary implementation, UE device 180 may connect to data network 140 via core network 130. Data network 140 may also include and/or be connected to a local area network (LAN), a wide area network (WAN), a metropolitan area network (MAN), an autonomous system (AS) on the Internet, an optical network, a cable television network, a satellite network, a wireless network, an ad hoc network, an intranet, or a combination of networks.

Network controller system 150 may include a network device or AF to provide for on-demand configuration of enhanced quality of service (QOS), of subscriber sessions, by application developers. Network controller system 150 may receive, via an external API described further herein, a service request for a bearer associated with an external application. Network controller system 150 may perform authentication and authorization for the service request and may generate a network configuration request, such as a differentiated QoS flow request, for core network 130 based on information in the service request. Network controller system 150 may send, in response to receiving the service request, the network configuration request to an exposure function in the core network.

End devices 180 include a device that may have computational and/or communication capabilities (e.g., wireless, wired, optical, etc.). End device 180 may be implemented as a mobile device, a portable device, a stationary device (e.g., a non-mobile device), a device operated by a user, or a device not operated by a user. For example, end device 180 may be implemented as a smartphone, a mobile phone, a personal digital assistant, a tablet, a netbook, a wearable device (e.g., a watch, glasses, etc.), a computer, a gaming device, a music device, an Internet of Things (IoT) device, a drone, a smart device, or other type of wireless device (e.g., other type of UE). End device 180 may be configured to execute various types of software (e.g., applications, programs, etc.). The number and the types of software may vary among end devices 180.

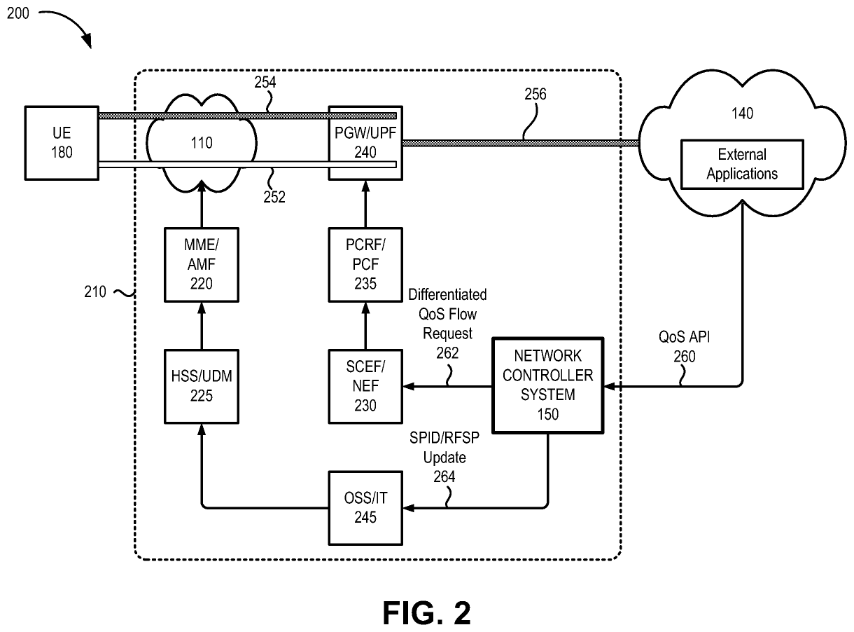

FIG. 2 is a block diagram illustrating exemplary network components in a portion 200 of network environment 100. Network portion 200 provides a high-level end-to-end architecture for on-demand configuration of enhanced QoS. As shown in FIG. 2, network portion 200 may include a PLMN domain 210 that includes components of access network 110, management network 120, and core network 130. PLMN domain 210 may provide bearers for communications between end device 180 (implemented and shown as UE 180) and external applications in data network 140, for example.

In FIG. 2, PLMN domain 210 is shown as including 4G or 5G mobile network components. In the case of a 5G network, PLMN domain 210 may include an AMF 220, a UDM 225, a Network Exposure Function (NEFs) 230, a PCF 235, a UPF 240, and an operations support system (OSS) 245. In the case of a 4G network, core network 140 may include MME 220, a HSS 225, a SCEF 230, a PCRF 235, a PGW 240, and an information technology (IT) function 245. The NFs shown in FIG. 2 may be hosted and executed by one or more network devices, such as core devices 135 and/or provider devices 125. Multiple NFs may be hosted and executed by a single network device, and the various NFs of FIG. 2 may be distributed across multiple network devices.

In network portion 200, network controller system 150 may act as an AF to manage dynamic network configurations. On the PLMN side, network controller system 150 may interface with core network elements (e.g., SCEF/NEF 230 and OSS/IT 245) using 3GPP interfaces. On the external side, network controller system 150 may expose an API, on an external interface, for application developers for on-demand configuration of a QoS session.

Network controller system 150 may expose to application developers an easy to use API to submit service requests to configure network parameters, such as a QOS API 260. For a given session with a UE, the session may be supported using a default bearer 252 or a dedicated bearer 254, either of which may tie into a dedicated transport bearer 256. The dedicated bearer 254 may be configured to meet requirements set by certain QoS parameters, such as low latency, high bandwidth, ultra-high reliability, etc. The default bearer 252 may provide adequate service levels during normal conditions, but may not be adequate for some applications and/or may be subject to delays/preemption in the event of RAN congestion. Thus, selection of the appropriate default bearer 252 or dedicated bearer 254 may significantly impact the end-user experience, and application developers may benefit from the ability to select different bearers 252/254 on demand.

RAN 110 and PGW/UPF 240 may support user plane communications over bearers 252 or 254. MME/AMF 220 performs authentication, authorization, and mobility management for UE 180. HSS/UDM 225 stores and maintains subscriber profiles and may perform, based on the information stored in the data structure, a user authentication function, a session establishment function, and/or an access authorization function.

SCEF/NEF 230 may provide an interface for secure delivery of mobile network services to external entities (e.g., external applications in data network 140). SCEF/NEF 230 may act as gateways between applications executed by external devices 145 and UEs 180 over PLMN domain 210. PCRF/PCF 235 may provide policies/rules to control plane network devices and make policy decisions based on subscription information, among other functions.

OSS/IT 245 may include a network monitoring system, a network provisioning system, a network management system, a self-optimizing network (SON) system, etc. OSS/IT 245 may manage the physical components of access network 110 and/or core network 130.

QOS API 260 may accept structured input from application developers to identify application requirements for QoS differentiation and allow network controller system 150 to properly configure the network to support the requirements. The application developer (e.g., in data network 140) can make a request via the QOS API 260. The network controller system 150 may perform a validation procedure (e.g., authentication and authorization) and then transform the request from the application developers into a format that can be understood in PLMN domain 210 (e.g., core network 130). For example, based on a request via QOS API 260, network controller system 150 may use a non-IP interface to provide a network configuration request, such as differentiated QoS flow request 262, to an exposure function (e.g., SCEF/NEF 230) based on information received via QOS API 260. More particularly, network controller system 150 may send differentiated QoS flow request 262 to SCEF 230 via a T8 interface or, alternatively, to NEF 230 via an N33 interface. Furthermore, based on a request via QOS API 260, network controller system 150 may provide a subscriber profile identifier (SPID)/RFSP update 264 to OSS/IT 245 to dynamically provision SPID/RFSP values.

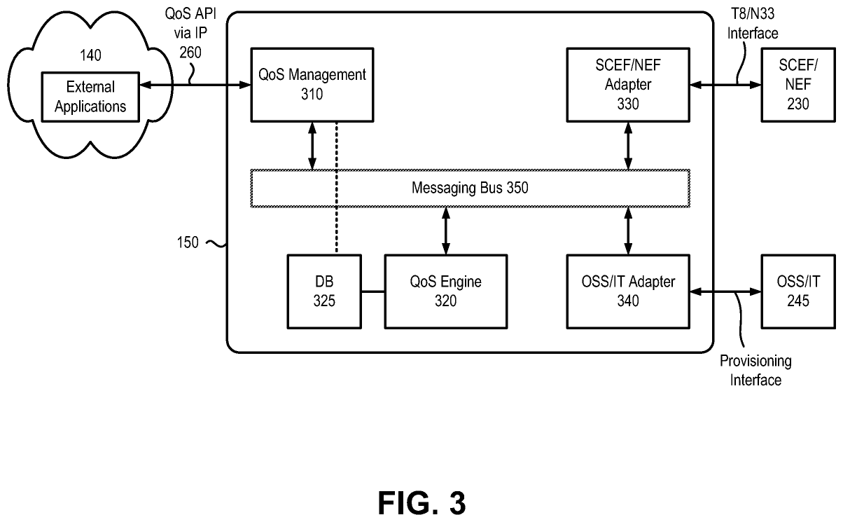

FIG. 3 is a diagram of exemplary logical components and communications of network controller system 150. As shown in FIG. 3, network controller system 150 may include QoS management service 310, QoS engine 320, SCEF adapter 330, OSS/IT adapter 340, and messaging bus 350. According to an implementation, each of QoS management service 310, QoS engine 320, SCEF adapter 330, and OSS/IT adapter 340 may be implemented as a microservice within network controller system 150.

QoS management service 310 may expose the QoS controller API (e.g., QOS API 260) that will be leveraged by external applications (e.g., in data network 140) to invoke dynamic QoS request to PLMN domain 210. According to an implementation, QoS management service 310 may include an identity and access management function. QoS management service 310 may authenticate a user, application, or end device, associated with the external application in data network 140, to access network controller system 150. For example, in some instances, QoS management service 310 may use security tokens to enforce restricted access.

QoS engine 320 may support handling of main actions for network controller system 150, such as creation or termination of dedicated QoS bearers, maintaining the subscription states (e.g., dedicated bearer, default bearer, etc.) in database 325, creation or termination of SPID configuration, running regular jobs for monitoring of subscription status, etc. For example, QoS engine 320 may translate requests received via QOS API 260 into formats that can be used to interface with core network elements.

Database (DB) 325 may store a QoS status of subscription identifiers for requested events (e.g., create, update, delete, etc.). Thus, QoS engine 320 may use DB 325 to map an application request to a flow on a single QoS session and track terminating the flow when a request duration expires. Additionally, QoS engine 320 may implement backoff logic and mark a UE as unavailable, for specified time, to avoid frequent session requests.

SCEF/NEF adapter 330 may interface with SCEF 230 over a T8 interface for configuration of a requested QoS (e.g., to apply bearer 252 or 254). Alternatively, or additionally, SCEF/NEF adapter 330 may interface with NEF 230 over a N33 interface for configuration of the requested QoS.

OSS/IT adapter 340 may interface with OSS/IT 245 for configuration of SPID in HSS 225 and/or RFSP in UDM 225. OSS/IT adapter 340 may be used to initiate dynamic provisioning of RFSP values to support QoS configuration on demand.

Messaging bus 350 may support event-based communication among all the microservices within network controller system 150. For example, messaging bus 350 may be implemented as a publish-subscribe model using a message broker.

Although FIG. 3 shows examples of logical components of network controller system 150, in other implementations, network controller system 150 may include fewer components, different components, or additional components than depicted in FIG. 3. In addition, functions described as being performed by one of the logical components in FIG. 3 may alternatively be performed by another one or more of the components of network controller system 150.

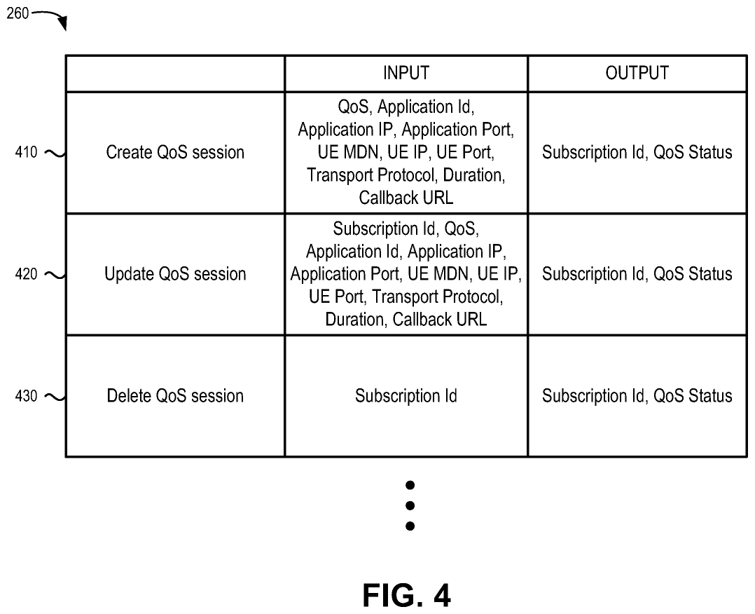

FIG. 4 is an example of features of API 260 for QoS differentiation. As shown in FIG. 4, the API may include structures for a create QoS session request 410, update QoS session request 420, and delete QoS session request 430. Inputs for create QoS session request 410, update QoS session request 420, and delete QoS session request 430 may be provided to network controller system 150 by an administrator of data network 140 (for an external application). Outputs for create QoS session request 410, update QoS session request 420, and delete QoS session request 430 may be returned to data network 140 by network controller system 150.

Inputs for create QoS session request 410 may generally include a QoS reference (e.g., indicating a desired QoS level/type), an application identifier, a UE IP address, and a flow description. Other inputs for create QoS session request 410 may include an application IP address, an application port, a UE Mobile Directory Number (MDN), a UE port, a transport protocol, a duration (e.g., a time limit for the dedicated QoS bearer), a callback URL (e.g., for network controller system 150 to provide response output). Output for create QoS session request 410 may include a new subscription ID (e.g., for a successfully created bearer) and a QoS status.

Inputs for update QoS session request 420 may include a subscription ID (e.g., as assigned in response to create QoS session request 410), a QoS reference (e.g., indicating an updated QoS level/type), an application identifier, an application IP address, an application port, a UE MDN, a UE IP address, a UE port, a transport protocol, a duration (e.g., a time limit for the updated QoS bearer), a callback URL (e.g., for network controller system 150 to provide response output). Output for update QoS session request 420 may include the subscription ID (e.g., for a successfully updated bearer) and an updated QoS status.

Input for delete QoS session request 430 may include a subscription ID (e.g., for the dedicated QoS bearer to be deleted). Output for delete QoS session request 430 may include the subscription ID and a QoS status (e.g., for a default bearer).

While FIG. 4 illustrates certain features of API 260, in other implementations API 260 may include features to support additional network configuration requests and/or information requests (collectively referred to as service requests). For example, API 260 may also support requests to identify available supported QoS levels, session notification callbacks, session status, session key performance indicators (KPI), etc. In still other implementations, API 260 may support on-demand network configuration for quality of experience or service level agreements.

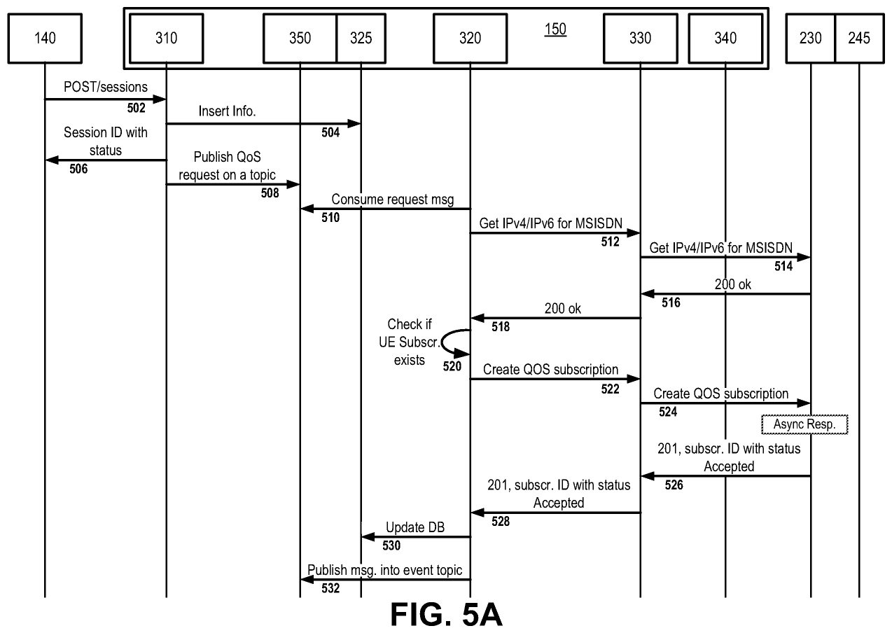

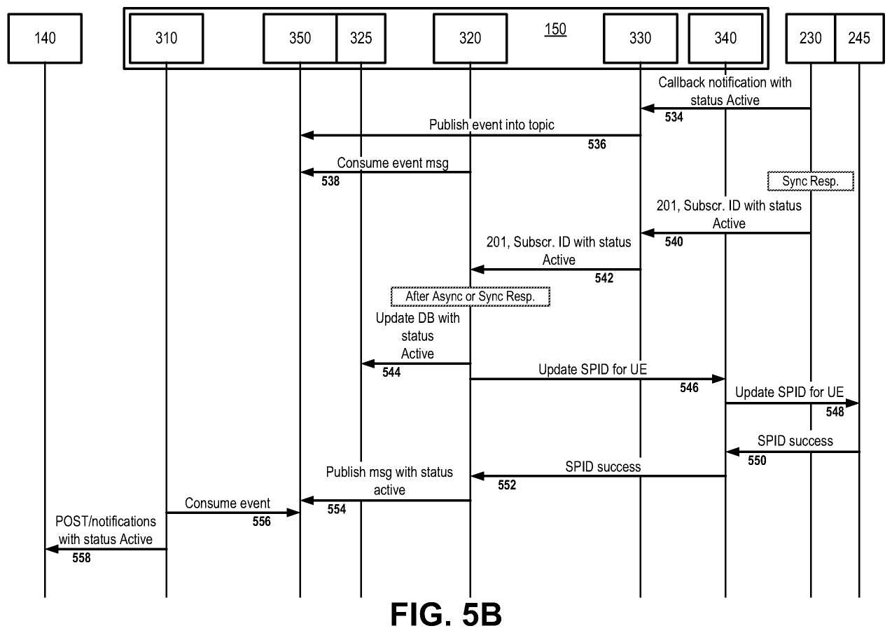

FIGS. 5A and 5B are signal flow diagrams illustrating internal communications within network controller system 150. At signal 502, network controller system 150 (QOS management 310) may receive an API call from an application server in data network 140 (e.g., via API 260) to create or update a QoS session with dedicated bearer establishment. The API call may include, for example, the input associated with create QoS session request 410 or update QoS session request 420. QoS management 310 may authenticate the application/request and assign a session ID for the request (not shown). At signal 504, QoS management 310 may insert the input information from the API call into database 325. At signal 506, QoS management 310 may respond to the application server (e.g., using API 260) by providing the session ID with an initial QoS status (e.g., “pending, active”).

At signal 508, QoS management 310 may publish to message bus 350 the QoS request of signal 502 on a relevant message bus topic (e.g., “client.qos.session”). At signal 510, QoS engine 320, which is subscribed to the topic, may consume/retrieve the request message from the message bus. In response to the request, at signal 512, QoS engine 320 may send a request to SCE/NEFF adapter 330 for IPV4 and/or IPv6 addresses for the impacted UE (e.g., UE 180) based on the UE's Mobile Station International Subscriber Directory Number (MSISDN). At signals 514-518, SCEF/NEF adapter 330 may, in turn, request the IPv4 and/or IPv6 addresses from SCEF/NEF 230, obtain the addresses from SCEF/NEF 230, and forward the IPV4 and/or IPv6 addresses to QoS engine 320.

At signal 520, QoS engine 320 may determine if a UE subscription with the SCEF already exists (e.g., there is an existing QoS bearer to be updated). For the purposes of illustration in FIG. 5A, assume that a SCEF UE subscription does not exist. Thus, at signal 522, QoS engine 320 may send a request to SCEF/NEF adapter 330 to create a QoS subscription (e.g., POST/subscriptions), and SCEF/NEF adapter 330 may forward the request to SCEF/NEF 230 at signal 524.

In the event of an asynchronous response, at signal 526, SCEF/NEF 230 may provide a new subscription ID with status (e.g., “accepted”) to SCEF/NEF adapter 330. At signal 528, SCEF/NEF adapter 330 may forward the new subscription ID with the status to QoS engine 320. Upon receipt, at signal 530, QoS engine 320 may update database 325 with the new SCEF subscription ID. At signal 532, QoS engine 320 may publish a message into the event topic with the status (e.g., “pending, active”). Referring to FIG. 5B, at signal 534, SCEF/NEF 230 may provide a callback notification with an updated status (e.g., “active”) to SCEF/NEF adapter 330. At signal 536, SCEF/NEF adapter 330 may publish the callback event into the message bus 350 under the appropriate topic (e.g., “scef.qos.notification”). At signal 538, QoS engine 320, which is subscribed to the topic, may consume/retrieve the status message from the message bus.

In the event of a synchronous response, at signal 540, SCEF/NEF 230 may provide a new subscription ID with status (e.g., “Active”) to SCEF/NEF adapter 330. At signal 542, SCEF/NEF adapter 330 may forward the new subscription ID with status to QoS engine 320.

After QoS engine 320 receives the new subscription ID with active status (e.g., either via the asynchronous or synchronous response process, QoS engine 320 may, at signal 544, update database 325 against the SCEF subscription ID with the active status. Additionally, as signal 546, QoS engine 320 may provide to OSS/IT adapter 340 an updated SPID for the UE. At signal 548, OSS/IT adapter 340 forwards the updated SPID for the UE to OSS/IT 245.

OSS/IT 245 may receive the updated SPID information and, at signal 550, respond to OSS/IT adapter 340 when the SPID is successfully provisioned. At signal 552, OSS/IT adapter 340 may relay the SPID success message to QoS engine 320. At signal 554, QoS engine 320 may publish to message bus 350 the SPID success message with the status active under the appropriate topic (e.g., “engine.qos.event”). At signal 556, QoS management 310, which is subscribed to the topic, may consume/retrieve the status message from the message bus. At signal 558, QoS management 310 may notify an application server in data network 140 (e.g., via API 260) of the updated QoS status to active.

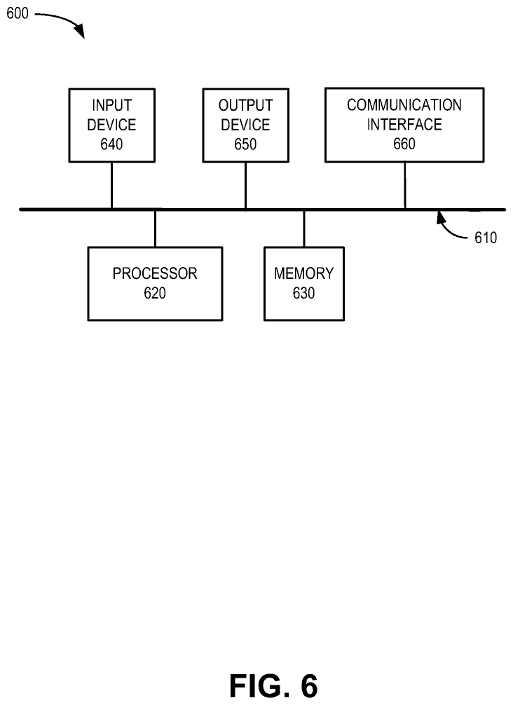

FIG. 6 is a diagram illustrating example components of a device 600 according to an implementation described herein. Access devices 115, provider devices 125, core devices 135, network controller system 150, UE 180, MME/AMF 220, HSS/UDM 225, SCEF/NEF 230, PCRF/PCF 235, PGW/UPF 240, OSS/IT 245, and/or other components of network environment 100 may be implemented by one or more devices 600.

As shown in FIG. 6, device 600 may include a bus 610, a processor 620, a memory 630, an input device 640, an output device 650, and a communication interface 660. Bus 610 may include a path that permits communication among the components of device 600. Processor 620 may include any type of single-core processor, multi-core processor, microprocessor, latch-based processor, and/or processing logic (or families of processors, microprocessors, and/or processing logics) that interprets and executes instructions. In other embodiments, processor 620 may include an application-specific integrated circuit (ASIC), a field-programmable gate array (FPGA), and/or another type of integrated circuit or processing logic.

Memory 630 may include any type of dynamic storage device that may store information and/or instructions, for execution by processor 620, and/or any type of non-volatile storage device that may store information for use by processor 620. For example, memory 630 may include a random access memory (RAM) or another type of dynamic storage device, a read-only memory (ROM) device or another type of static storage device, a content addressable memory (CAM), a magnetic and/or optical recording memory device and its corresponding drive (e.g., a hard disk drive, optical drive, etc.), and/or a removable form of memory, such as a flash memory.

Input device 640 may allow an operator to input information into device 600. Input device 640 may include, for example, a keyboard, a mouse, a pen, a microphone, a remote control, an audio capture device, an image and/or video capture device, a touch-screen display, and/or another type of input device. In some embodiments, device 600 may be managed remotely and may not include input device 640. In other words, device 600 may be “headless” and may not include a keyboard, for example.

Output device 650 may output information to an operator of device 600. Output device 650 may include a display, a printer, a speaker, and/or another type of output device. For example, device 600 may include a display, which may include a liquid-crystal display (LCD) for displaying content to the customer. In some embodiments, device 600 may be managed remotely and may not include output device 650. In other words, device 600 may be “headless” and may not include a display, for example.

Communication interface 660 may include a transceiver that enables device 600 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 660 may include a transmitter that converts baseband signals to radio frequency (RF) signals and/or a receiver that converts RF signals to baseband signals. Communication interface 660 may be coupled to one or more antennas/antenna arrays for transmitting and receiving RF signals.

Communication interface 660 may include a logical component that includes input and/or output ports, input and/or output systems, and/or other input and output components that facilitate the transmission of data to other devices. For example, communication interface 660 may include a network interface card (e.g., Ethernet card) for wired communications and/or a wireless network interface card for wireless communications. Communication interface 660 may also include a universal serial bus (USB) port for communications over a cable, a Bluetooth™M wireless interface, a radio-frequency identification (RFID) interface, a near-field communications (NFC) wireless interface, and/or any other type of interface that converts data from one form to another form.

As will be described in detail below, device 600 may perform certain operations relating to providing on-demand configuration of enhanced QoS. Device 600 may perform these operations in response to processor 620 executing software instructions contained in a computer-readable medium, such as memory 630. A computer-readable medium may be defined as a non-transitory memory device. A memory device may be implemented within a single physical memory device or spread across multiple physical memory devices. The software instructions may be read into memory 630 from another computer-readable medium or from another device. The software instructions contained in memory 630 may cause processor 620 to perform processes described herein. Alternatively, hardwired circuitry may be used in place of, or in combination with, software instructions to implement processes described herein. Thus, implementations described herein are not limited to any specific combination of hardware circuitry and software.

Although FIG. 6 shows exemplary components of device 600, in other implementations, device 600 may include fewer components, different components, additional components, or differently arranged components than depicted in FIG. 6. Additionally, or alternatively, one or more components of device 600 may perform one or more tasks described as being performed by one or more other components of device 600.

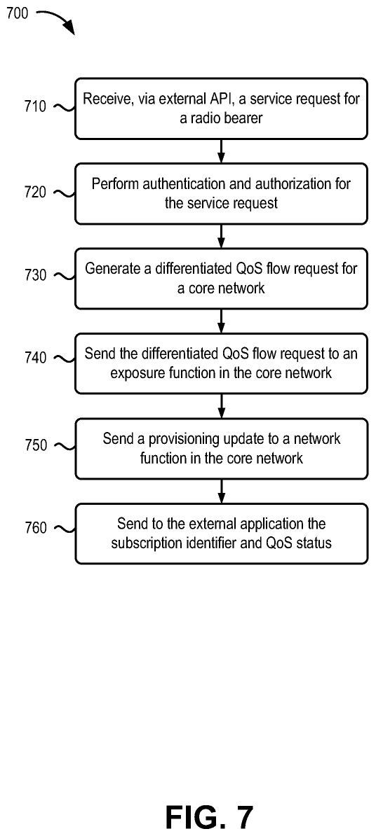

FIG. 7 is a flow diagram illustrating an exemplary process 7000 for providing on-demand configuration of enhanced QoS, according to an implementation described herein. In one implementation, process 700 may be implemented by network controller system 150. In another implementation, process 700 may be implemented by network controller system 150 in conjunction with one or more other network elements in network portion 200.

Process 700 may include receiving, via an external API, a service request for a bearer associated with an external application (block 710). For example, network controller system 150 may receive, via QOS API 260, a service request from an external application in data network 140. The service request may include, for example, create QoS session request 410, update QoS session request 420, delete QoS session request 430, or another type of network configuration request for a session between a UE (e.g., UE 180) and the external application. Requests provided via QOS API 260 may provide a structured user interface for application developers to define QoS requests/requirements and may be provided to network controller system 150 using Internet Protocol.

Process 700 may further include performing authentication and authorization for the service request (block 720). For example, network controller system 150 (e.g., QoS management 310) may authenticate the user/application to access services on network controller system 150.

Process 700 may also include generating a differentiated QoS flow request for a core network (block 730) and sending the differentiated QoS flow request to an exposure function in the core network (block 740). For example, network controller system 150 (e.g., QoS engine 320 and SCEF/NEF adapter 330) may use information from the service request to create a network configuration request, such as a QoS subscription request, that is forwarded to SCEF/NEF 230.

Process 700 may also include sending a provisioning update to a network function in the core network (block 750) and sending to the external application the subscription identifier and QoS status for the session (block 760). For example, network controller system 150 (e.g., OSS/IT adapter 330) may send a SPID update or a RFSP update to OSS/IT 245 to associate the QoS session settings with a subscriber profile. Network controller system 150 (e.g., QoS management service 310) may use callback information from the external application's initial QoS request to provide the subscription identifier and QoS status for the session.

Systems and methods described herein provide for on-demand configuration of enhanced quality of service (QOS), of subscriber sessions, by application developers. A network device may receive, via an external interface, a service request for a bearer associated with an external application. The network device may perform authentication and authorization for the service request, and may generate a network configuration request (e.g., a differentiated QoS flow request or another configuration request) for a core network, based on information in the service request. The network device may send, in response to receiving the service request, the network configuration request to an exposure function in the core network. While systems and methods have been described primarily in the context of service requests and network configuration requests related to differentiated QoS, in other implementations the systems and methods may support other types of on demand network configurations.

As set forth in this description and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration, but is not intended to be exhaustive or to limit the embodiments to the precise form disclosed. Accordingly, modifications to the embodiments described herein may be possible. Thus, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while series of signals and blocks have been described with regard to the processes illustrated in FIGS. 2, 3, 5A, 5B, and 6, the order of the signals and blocks may be modified according to other embodiments. Further, non-dependent signals or blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware or a combination of hardware and software.

Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 620) of a device. A non-transitory storage medium includes one or more of the storage mediums described in relation to memory 630.

To the extent the aforementioned embodiments collect, store or employ personal information of individuals, it should be understood that such information shall be collected, stored and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such. All structural and functional equivalents to the elements of the various aspects set forth in this disclosure that are known or later come to be known are expressly incorporated herein by reference and are intended to be encompassed by the claims.

What is claimed is:

1. A method, comprising:
receiving, by a network device and via an external interface, a service request for a bearer associated with an external application;
performing, by the network device, authentication and authorization for the service request;
generating, by the network device, a network configuration request for a core network, based on information in the service request; and
sending, by the network device and in response to receiving the service request, the network configuration request to an exposure function in the core network.

2. The method of claim 1, wherein the service request includes:
a requested quality of service (QOS) level for a flow,
an application identifier,
an application port,
a user equipment (UE) port, and
a callback uniform resource locator (URL).

3. The method of claim 1,
wherein receiving the service request includes receiving the service request via an Internet Protocol (IP) interface; and
wherein sending the network configuration request includes sending a differentiated quality of service (QOS) flow request via a non-IP interface.

4. The method of claim 1, wherein sending the network configuration request includes sending the network configuration request to the exposure function via one of a T8 interface or an N33 interface.

5. The method of claim 1, wherein sending the network configuration request includes sending a differentiated quality of service (QOS) flow request to a service capability exposure function (SCEF) for a 4G network.

6. The method of claim 1, wherein sending the network configuration request includes sending the differentiated quality of service (QOS) flow request to a network exposure function (NEF) for a 5G network.

7. The method of claim 1, wherein the service request includes one of:
a request to create a quality of service (QOS) session,
a request to update an existing QoS session, or
a request to delete a QoS session.

8. The method of claim 1, wherein the service request identifies a type of differentiated quality of service (QOS) for the bearer.

9. The method of claim 1, further comprising:
sending, in response to receiving the service request, a subscriber profile identifier (SPID) update to a network function in the core network.

10. The method of claim 1, further comprising:
initiating dynamic provisioning of radio access technology (RAT) frequency selection priority (RFSP) values in response to the service request.

11. A network device, comprising:
a processor configured to:
receive, via an external interface, a service request for a bearer associated with an external application;
perform authentication and authorization for the service request;
generate a network configuration request for a core network, based on information in the service request; and
send, in response to receiving the service request, the network configuration request to an exposure function in the core network.

12. The network device of claim 11, wherein, when receiving the service request, the processor is further configured to:
receive the service request via a dedicated API using Internet Protocol.

13. The network device of claim 12, wherein the processor is further configured to:
send, using the dedicated API, a subscription identifier and quality of service (QOS) status for a flow associated with the service request.

14. The network device of claim 11, wherein, when sending the network configuration request, the processor is further configured to:
send the network configuration request to a service capability exposure function (SCEF) via a T8 interface.

15. The network device of claim 11, wherein, when sending the network configuration request, the processor is further configured to:
send the network configuration request to a network exposure function (NEF) via an N33 interface.

16. The network device of claim 11, wherein the service request includes:
a requested quality of service (QOS) level for a service flow,
an application identifier,
an application IP address,
a user equipment (UE) IP address, and
a duration for the requested service.

17. The network device of claim 11, wherein the processor is further configured to:
send, in response to receiving the service request, a subscriber profile identifier (SPID) update to a network function in the core network; and
initiate dynamic provisioning of radio access technology (RAT) frequency selection priority (RFSP) values in response to the service request.

18. A non-transitory computer-readable medium containing instructions executable by at least one processor, the computer-readable medium comprising one or more instructions for:
receiving, by a network device and via an external interface, a service request for a bearer associated with an external application;
performing, by the network device, authentication and authorization for the service request;
generating, by the network device, a network configuration request for a core network, based on information in the service request; and
sending, by the network device and in response to receiving the service request, the network configuration request to an exposure function in the core network.

19. The non-transitory computer-readable medium of claim 18, further comprising one or more instructions for:
receiving the service request via a dedicated API using Internet Protocol; and
send, to an external network function and using the dedicated API, a subscription identifier and quality of service (QOS) status for a flow associated with the service request.

20. The non-transitory computer-readable medium of claim 18, further comprising one or more instructions for:
dynamically updating, based on sending the network configuration request, a subscriber profile identifier (SPID) in the core network.
